(19) United States
(12) Patent Application Publication
(10) Pub. No.: US 2025/0264636 A1
(43) Pub. Date: Aug. 21, 2025

(54) METHODS FOR FABRICATING OPTICAL METASURFACES

(71) Applicant: Wisconsin Alumni Research Foundation, Madison, WI (US)

(72) Inventors: Filiz Yesilkoy, Middleton, WI (US); Yuber Samir Sanchez Rosas, Madison, WI (US); Wihan Adi, Madison, WI (US)

(21) Appl. No.: 18/581,004

(22) Filed: Feb. 19, 2024

(51) Int. Cl. G02B 1/00; G01J 3/02; G02B 27/00

(52) U.S. Cl. CPC G02B 1/002; G01J 3/0205; G02B 27/0012

(57) ABSTRACT

Methods of fabricating optical metasurfaces are provided which may comprise forming a free-standing membrane from a wafer and forming a metasurface pattern in the free-standing membrane to provide an optical metasurface comprising the free-standing membrane having defined therein, a periodic array of flow-through apertures, the flow-through apertures having subwavelength dimensions and arranged according to the metasurface pattern, wherein the metasurface pattern is configured to confine incoming light within the flow-through apertures. The optical metasurfaces and devices (e.g., sensors and spectrometers) comprising the optical metasurfaces are also provided.

### REFERENCE TO GOVERNMENT RIGHTS

This invention was made with government support under EB034411 awarded by the National Institutes of Health. The government has certain rights in the invention.

### BACKGROUND

Optical metasurfaces enable unprecedented control over electromagnetic wave manipulation. By leveraging powerful resonance mechanisms supported by subwavelength structures arranged in two-dimensional configurations, these engineered interfaces can enable on-chip wavefront shaping, phase and direction, and polarization control. In addition to their free-space wave modulation capabilities, resonant metasurfaces can spatially and temporally confine light, generating powerful photonic cavities in the vicinity of resonators.

### SUMMARY

Provided are methods of fabricating optical metasurfaces. The optical metasurfaces and devices (e.g., sensors, spectrometers) incorporating the optical metasurfaces are also provided.

The present fabrication methods provide optical metasurfaces which exhibit extremely high electric field enhancements within apertures of the optical metasurfaces upon coupling light (e.g., mid-infrared light) into the optical metasurfaces. As such, the optical metasurfaces may be used in a variety of applications based on light-matter interactions, including chemical sensing and polaritonic chemistry applications. In contrast to conventional optical metasurfaces fabricated using conventional techniques, apertures of the present optical metasurfaces are fully accessible by samples present within the apertures of the optical metasurfaces and thus, enable microfluidic control of these samples. Moreover, the present methods are compatible with complementary metal-oxide-semiconductor (CMOS) processing techniques and materials, enabling more efficient and more cost-effective industrial scale manufacturability as compared to conventional techniques for fabricating optical metasurfaces.

By way of illustration, the Example below describes mid-infrared optical metasurfaces which were fabricated by patterning free-standing Si-membranes so as to achieve unique light-trapping capabilities in accessible air modes. Specifically, the Brillouin zone folding technique was employed to excite quasi-bound states in the continuum (q-BIC) resonances with high quality factors. Due to the surprisingly high electrical field enhancements with the apertures of the optical metasurfaces, these structures were able to induce vibrational strong coupling (VSC) between the C═O stretching mode of polymethyl methacrylate molecules and the open planar q-BIC cavities supported by the low-loss Si metasurfaces at various detuning frequencies and thicknesses. This new way of efficiently trapping mid-infrared radiation into air cavities provides a critical platform for biological and chemical sensing, quantum-coherent light-matter interactions and polaritonic chemistry.

The optical metasurfaces fabricated using the present methods may also be used as geometrically tunable narrow-band optical filters. As further described herein, aperture geometries with in-plane asymmetry have been employed to support q-BIC resonances. By contrast to existing optical metasurfaces fabricated on solid substrates, the q-BIC modes generated by the present optical metasurfaces have resonances with sharp peaks in transmission spectra, resonance peaks full width half maximum (FWHM) ranges between 1 cm⁻¹ and 225 cm⁻¹ (this includes from 10 cm⁻¹ to 200 cm⁻¹ and from 25 cm⁻¹ to 150 cm⁻¹.) As such, an array of the present optical metasurfaces with varying spectral resonance peaks can be used as a filter array enabling a variety of applications such as spectrometry. By integrating the optical metasurface filter arrays with two-dimensional photon detector arrays, the intensity measurements by the detector pixels can be converted into spectral information and miniaturizable on-chip single-shot spectrometers can be developed.

In one aspect, methods of fabricating optical metasurfaces are provided. In an embodiment, such a method comprises forming a free-standing membrane from a wafer and forming a metasurface pattern in the free-standing membrane to provide an optical metasurface comprising the free-standing membrane having defined therein, a periodic array of flow-through apertures, the flow-through apertures having subwavelength dimensions and arranged according to the metasurface pattern, wherein the metasurface pattern is configured to confine incoming light within the flow-through apertures.

In another aspect, the optical metasurfaces are provided. In an embodiment, an optical metasurface comprises a free-standing membrane having defined therein, a periodic array of flow-through apertures, the flow-through apertures having subwavelength dimensions and arranged according to a metasurface pattern, wherein the metasurface pattern is configured to confine incoming light within the flow-through apertures. Devices, e.g., sensors and spectrometers, comprising the optical metasurfaces are also provided.

Other principal features and advantages of the disclosure will become apparent to those skilled in the art upon review of the following drawings, the detailed description, and the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

Illustrative embodiments of the disclosure will hereafter be described with reference to the accompanying drawings, wherein like numerals denote like elements.

FIGS. 1A-1G: Substrate-less qBIC-supporting Si-membrane metasurfaces for VSC. FIGS. 1A, 1B show schematics of periodic radius perturbation in a 2-D square-lattice hole array to create a qBIC-supporting double-hole design in Si-membranes. FIG. 1C shows a calculated band diagram of the TE modes supported by single (blue) and double-hole (red) designs. X is the edge of the Brillouin zone of the single-hole, and X′ is that of the double-hole metasurface designs. FIG. 1D shows simulated transmission spectra of the double-hole design acquired by sweeping the asymmetry parameter, Δr, with other geometric parameters set for resonances in the mid-infrared. FIG. 1E shows three spectra indicated by white dashed lines in FIG. 1D and are plotted to show the emerging BZF-qBIC modes when Δr approaches 0. The Q-factors of qBIC TE and qBIC TM modes slowly increase when Δr approaches zero and disappear when Δr=0, whereas those of GM TE and GM TM remain relatively constant. FIG. 1F shows schematics of strong coupling between frequency-tuned PMMA C═O vibrational mode and the qBIC TM mode. FIG. 1H shows the measured Rabi mode splitting forming upper (UP) and lower polaritons (LP) induced by the VSC (top) between the PMMA C═O vibrational mode (gray dashed lines) and bare metasurface resonance mode (gray), where the strong coupling region is shaded in gray. FIG. 1G shows simulated transmission spectra, revealing an anti-crossing pattern as the qBIC TM mode is spectrally swept through the C═O vibrational mode by geometrically tuning the metasurface parameters via a scaling factor(s).

FIGS. 2A-2E: Substrate-less Si-membrane metasurfaces fabrication. FIG. 2A shows an image of an unpatterned free-standing Si-membrane chip with a membrane window of 2.8 mm×2.8 mm. FIG. 2B shows an image of a 4×4 array of BZF-qBIC-supporting metasurfaces, where distinct colors captured by the camera in the visible correspond to variations in the geometric parameters of the double-hole unit cell. FIGS. 2C, 2D show scanning electron microscopy (SEM) images of a metasurface (FIG. 2C) and a double-hole unit cell with its critical geometric parameters (FIG. 2D). FIG. 2E shows an illustrative fabrication process of substrate-less dielectric metasurfaces. An image to the right shows a comparative structure formed on a solid, bulk substrate as is used in conventional techniques for fabricating optical metasurfaces. The present approach eliminates the need for a solid substrate by embedding the resonator voids in a robust Si-membrane.

FIGS. 3A-3D: Bound states in the continuum resonances by Brillouin zone folding (BZF-BICs). FIGS. 3A, 3C show simulated transmission spectra with normally incident light (Γ-point) showing TE (FIG. 3A) and TM (FIG. 3C) modes for single-hole (blue) and double-hole (red) metasurface designs. FIGS. 3B, 3D show band diagrams showing the dispersion relations of TE (FIG. 3B) and TM (FIG. 3D) modes for single-hole (blue) and double-hole (red) metasurface designs.

FIGS. 4A-4H: qBIC open photonic cavities generated by Si-membrane metasurfaces. FIGS. 4A-4D show electric field enhancement maps from cross sections of holes associated with the qBIC TE (FIG. 4A), GM TE (FIG. 4B), qBIC TM (FIG. 4C), and GM TM (FIG. 4D) resonance modes. FIGS. 4E, 4G show electric field enhancement profiles along the dashed lines indicated on the maps for TE (FIG. 4E) and TM (FIG. 4G) modes. These figures show how the qBIC TE and TM modes (red lines, top) trap light efficiently into the air voids compared to the GM TE and TM modes (blue lines, bottom). FIGS. 4F, 4H show bulk refractive index sensitivities of TE (FIG. 4F) and TM (FIG. 4H) modes which demonstrate how the accessible vacuum photonic cavities generated by qBIC modes are significantly better suited for enhancing light-matter interactions than the GM modes.

FIGS. 5A-5D: Optical characterization of fabricated BZF-qBIC metasurfaces. FIG. 5A shows SEM images of the fabricated metasurfaces' unit cells with various Δr and FIG. 5B shows their corresponding spectral responses demonstrating the resonance modes. The spectral region of qBIC TE and TM modes are shaded; no qBIC modes are detected when Δr=0 nm, corroborating the simulation findings. The measured qBIC resonance amplitudes decrease with decreasing Δr, typical of qBIC modes. FIGS. 5C, 5D show that the spectral positions of the qBIC resonance modes may be tuned by varying the geometric metaunit parameters in double-hole design using scaling parameter s (inset, FIG. 5C). Numerically simulated (FIG. 5C) and measured (FIG. 5D) spectra of the TM modes are tuned to a higher wavenumber region than the C═O absorption band to accommodate for the expected redshift upon PMMA deposition into the cavities.

FIGS. 6A-6F: Vibrational strong coupling in the BZF-qBIC cavities generated by Si-membrane metasurfaces. FIGS. 6A, 6D show spectra showing the VSC between the PMMA molecules' C═O vibrational transition (shaded gray) and the qBIC TM modes, which are spectrally tuned to various wavenumbers. Spectra collected before coating the metasurface with PMMA (dashed gray lines) and after coating (solid, colored lines) are shown. Experimentally measured (FIG. 6A) and simulated (FIG. 6D) spectral responses both show polariton formation and Rabi splitting at varying values due to resonance detuning as the qBIC mode sweeps the C═O absorption band. FIGS. 6B, 6E show the experimentally measured (FIG. 6B) and simulated (FIG. 6E) Rabi splitting values plotted as a function of resonance detuning show the zero-detuning wavenumber at the minimum Rabi splitting value. FIGS. 6C, 6F show that the anti-crossing behavior, a signature of VSC, was observed both in experimental measurements (FIG. 6C) and simulation results (FIG. 6F). The gray dashed line represents PMMA C═O bond's absorbance resonance and the pink dashed line represents unperturbed qBIC TM resonances, respectively.

FIGS. 7A-7B: VSC strength as a function of molecule quantity in the photonic cavity. FIG. 7A shows the spectral response of VSC between the qBIC TM mode and PMMA C═O vibrational band (shaded gray) as the PMMA thickness filling the cavity increases. The bare metasurface resonance is also shown as the lowest curve. FIG. 7B shows experimentally measured (yellow) and simulated (magenta) Rabi splitting values as a function of PMMA thickness. The Rabi splitting increases as the coupling strength is enhanced with a growing number of PMMA molecules that interact with the cavity.

FIG. 8A shows an SEM image of another illustrative Si optical metasurface patterned using a tilted-rod design. The unit cell of the design is shown in the inset. FIG. 8B shows the E field enhancement along a xy cross-section of a portion of the optical metasurface. FIG. 8C plots the simulation calculated spectral response of the optical in metasurface. FIG. 8D plots the experimentally measured spectral response of the optical metasurface.

FIG. 9A shows an SEM image of another illustrative Si optical metasurface patterned using a truncated-circle design. The unit cell of the design is shown in the inset.

FIG. 9B shows the E field enhancement along a xy cross-section of a portion of the optical metasurface. FIG. 9C plots the simulation calculated spectral response of the optical metasurface. The truncated-circle metasurface design has two resonance modes, one at 1495 cm⁻¹ and the other one at 1660 cm⁻¹.

FIG. 10 is a schematic illustration of a spectrometer comprising an array of optical metasurfaces with varying transmission peak positions.

FIG. 11 is a schematic illustration of a sensor comprising the illustrative optical metasurface of FIG. 1B.

### DETAILED DESCRIPTION

Provided are methods of fabricating optical metasurfaces. The optical metasurfaces and devices (e.g., sensors, spectrometers) incorporating the optical metasurfaces are also provided.

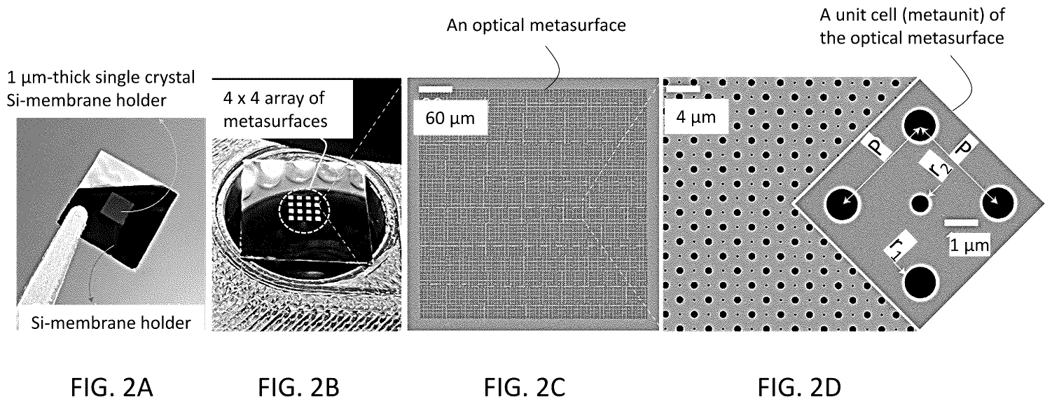

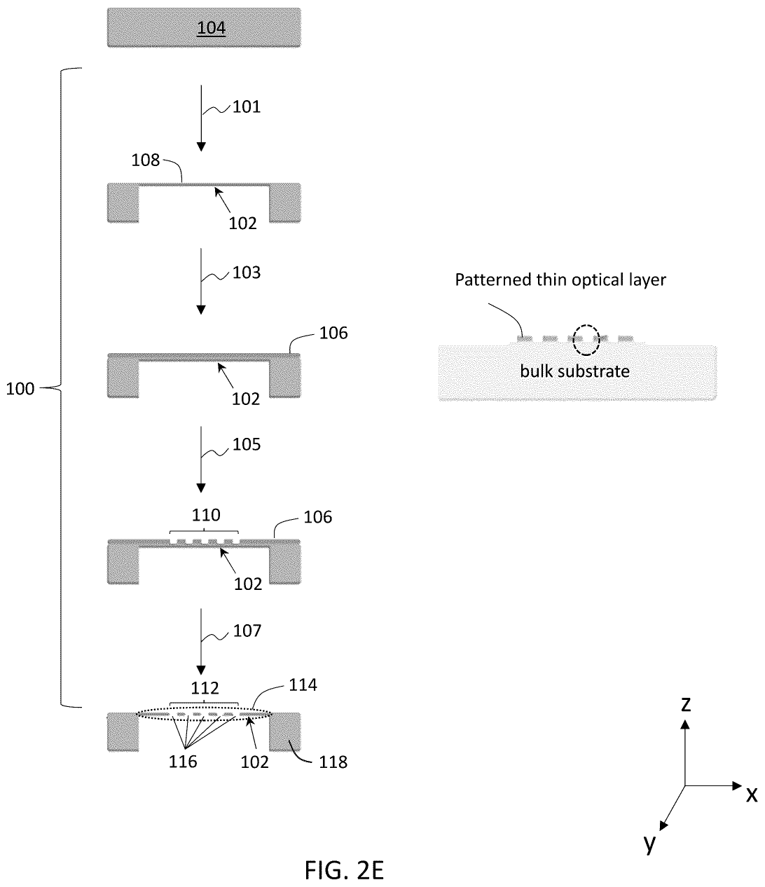

The present methods of fabricating optical metasurfaces comprise forming a membrane from a wafer and forming a metasurface pattern in the membrane to provide an optical metasurface comprising the membrane having defined therein, a periodic array of apertures, the apertures having subwavelength dimensions and arranged according to the metasurface pattern. An illustrative such method 100 is illustrated in FIG. 2E. The method 100 comprises forming a membrane 102 from a wafer 104 (step 101); applying a resist layer 106 on a surface 108 of the membrane 102 (step 103); forming a resist pattern 110 in the resist layer 106, the resist pattern 110 corresponding to a metasurface pattern 112 (step 105); and forming the metasurface pattern 112 in the membrane 102 to provide an optical metasurface 114 comprising the membrane 102 having defined therein, a periodic array of apertures 116, the apertures 116 having subwavelength dimensions and arranged according to the metasurface pattern 112 (step 107). The sequence of steps shown in FIG. 2E is not intended to be limiting. For example, the resist layer 106 may be applied on a surface of the wafer 104, followed by forming the membrane 102 from the wafer 104, followed by forming the resist pattern 110 in the resist layer 106. As another example, the resist layer 106 may be applied on a surface of the wafer 104, followed by forming the resist pattern 110 in the resist layer 106, followed by forming the membrane 102 from the wafer 104.

The membrane of the present methods (including the membrane 102) is characterized by having a thickness (along the z axis as shown in FIG. 2E) that is substantially less than that of the other two dimensions of the membrane (x and y). This thickness generally depends upon the wavelength at which the optical metasurface and the light being coupled therein are under resonance. This wavelength may be referred to as a “metasurface resonance wavelength” (lᵣₑₛ). This includes having a thickness in a range of from no more than (λres/n)*2 to no less than (λres/n)*0.3, wherein lᵣₑₛ has been defined above and n is the refractive index of the membrane. By way of illustration, for a lᵣₑₛ of from 5 mm to 10 mm, the membrane thickness may be from 420 nm to 5.7 mm. The other two dimensions of the membrane are not particularly limited, although they are greater than its thickness. Thus, the membrane (and the optical metasurface) may be characterized as having a planar, two-dimensional morphology. This includes planar 2D morphology in which the surfaces thereof are free from any structure projecting from the surfaces. The shape of the membrane as defined by the two dimensions perpendicular to its thickness is not particularly limited. By being so thin, the membranes are distinguished from bulk substrates, which refers to a component having substantially greater thicknesses than those described above, including thicknesses of greater than about 50 μm.

The membrane of the present methods (including the membrane 102) is further characterized as being free-standing, by which it is meant the portion of the membrane in which the metasurface pattern is formed is not in contact with, and is thus, unsupported by, a bulk substrate. Thus, the membranes and the optical metasurfaces disclosed herein may be characterized as being “substrate-less.” The free-standing, substrate-less nature of the membranes does not preclude the membrane from being laterally surrounded by a frame 118 or similar structure, e.g., as shown in FIG. 2E. This frame 118 may be derived from the wafer 104 in which the membrane 102 is formed.

For purposes of comparison, an image to the right of those shown in FIG. 2E illustrates the conventional use of a bulk substrate to fabricate an optical metasurface using a conventional technique. In the comparative structure, a patterned thin optical layer is in contact with, and is thus supported by, the bulk substrate. Thus, the patterned thin optical layer is neither free-standing nor substrate-less and cannot be considered a membrane as defined by the present disclosure.

The membrane of the present methods (including the membrane 102) may be composed of a dielectric material that is transparent to the light to be coupled into the fabricated optical metasurface. The light to be coupled may be infrared (IR) light having a wavelength within the IR region of the electromagnetic spectrum. This includes mid-infrared (MIR) light having a wavelength in a range of from 2 μm to 12 μm. This includes from 2 μm to 10 μm, from 3 μm to 9 μm, and from 4 μm to 6 μm. The transparency of the dielectric material over any of these ranges may be at least 60%. This includes at least 70%, at least 80%, or at least 90%. Suitable MIR transparent dielectric materials include those comprising (or consisting of) Group IV elements such as Si, Ge, and combinations thereof and III-V semiconductors such as InP, InAs, GaAs, GaSb, and combinations thereof. The membrane (and the fabricated optical metasurface) may be free of a conductive material, e.g., a metal. The membrane (and the fabricated optical metasurface) may be composed entirely of (i.e., consist of) the selected dielectric material. Terms such as “free,” “entirely,” “consist,” and the like do not preclude the possible presence of impurities inherent to the fabrication techniques described herein.

As illustrated in FIG. 2E and further described in the Example, below, formation of the membrane 102 is carried out via lithography, including patterning an opening into a handle (e.g., a silicon handle) of a commercially available wafer (e.g., silicon-on-insulator wafer) and etching to release the membrane 102 (e.g., a single-crystalline silicon membrane). Formation of the metasurface pattern 112 is also carried out via lithography. The Example, below, describes an illustrative lithographic process, but various types of lithography employing various types of illumination (e.g., light, electron beam), various types of resists, and various types of etching (e.g., wet, dry) may be used. The metasurface pattern 112 to be formed in the membrane 102 is further described below. As noted above, the resist pattern 110 formed in the resist layer 106 is one corresponding to (i.e., giving rise to) the desired metasurface pattern 112. The correspondence may be direct as shown in FIG. 2E, wherein apertures defined in the resist layer 106 directly correspond to the apertures 116 defined in the membrane 102.

The apertures of the present optical metasurfaces (including the apertures 116) are characterized as being flow-through, by which it is meant a fluid (e.g., liquid or gas) is able to flow through the aperture, e.g., enter from one side of the aperture and exit from a different (e.g., opposite) side of the aperture. This feature is related to the free-standing, substrate-less nature of the membrane and renders the optical metasurfaces compatible with various microfluidic systems and microfluidic techniques. (Terms such as “cavities,” “holes,” and the like may be used to describe the present apertures, but the meaning of these terms is consistent with the flow-through characteristic described above.) The present apertures are by contrast to elements such as those circled in the comparative structure shown in the right image of FIG. 2E in which a fluid may enter into an element from one side but cannot flow through due to the underlying bulk substrate (the fluid would have to exit from the same side). Thus, the elements of the comparative structure are not “apertures” as this term is defined in the present disclosure.

The apertures of the present optical metasurfaces (including the apertures 116) are further characterized by having subwavelength dimensions. By “subwavelength dimensions,” it is meant that at least one dimension of the aperture is less than the wavelength of the light being coupled into the fabricated optical metasurface. As noted above, this wavelength may be a MIR wavelength. The dimension of an aperture taken along the z dimension of the aperture corresponds to the thickness of the membrane as described above. The other two dimensions (x, y) of the aperture may be independently selected; at least one of x, y is less than lᵣₑₛ, which has been defined above. The shape of the apertures is not particularly limited, but circular apertures may be characterized by a radius r and elliptical apertures may be characterized by major and minor radii, all of which may assume any of the values for x, y described above.

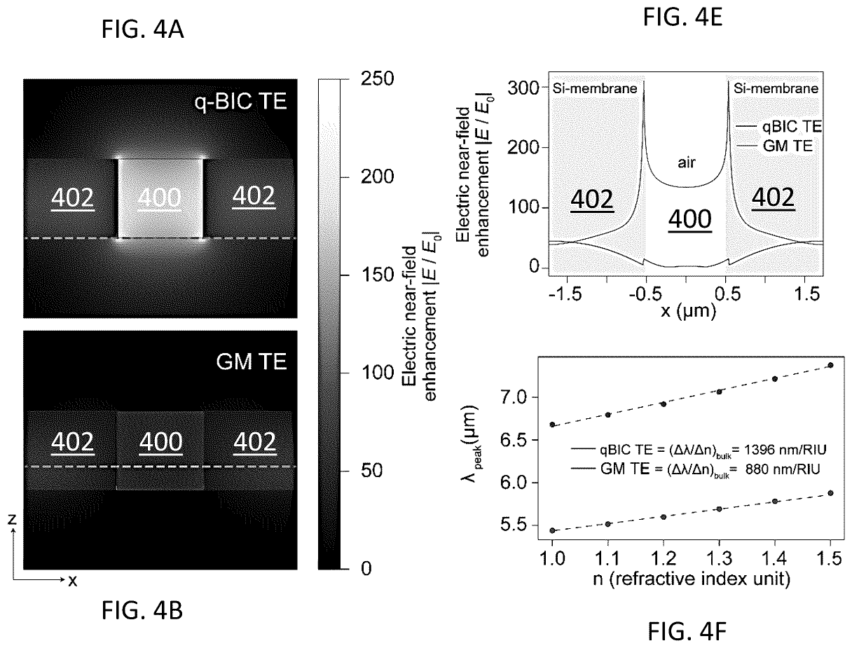

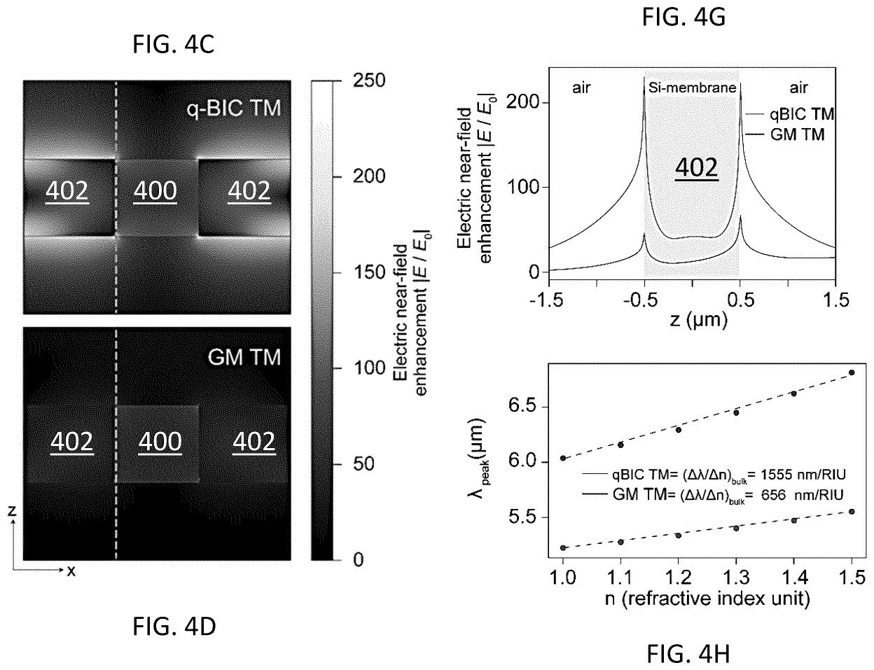

As noted above, the apertures of the present optical metasurfaces (including the apertures 116) form a periodic array and are otherwise arranged according to the metasurface pattern. The periodic array may be one-dimensional (1D) with the apertures extending in a single direction or a two-dimensional (2D) array with the apertures extending along two dimensions. A variety of metasurface patterns may be used, provided the metasurface pattern is configured to confine (i.e., trap) incoming light (e.g., MIR light) within the apertures defined in the membrane. More specifically, the configuration of the metasurface pattern is such that optical mode volumes, generated when the incoming light is resonant with an optical mode of the optical metasurface, are created within the apertures of the optical metasurface. Moreover, the optical mode supported by the optical metasurface is characterized by enhanced electric (E) (and/or magnetic (H)) field within these apertures. (Throughout the present disclosure, references to enhanced E field may refer to enhanced E and/or enhanced H field.) This feature of E field enhancement within the apertures is illustrated in FIG. 4A, showing the E field enhancement of a particular optical mode supported by an illustrative optical metasurface. Specifically, FIG. 4A shows the E field enhancement along x-z cross-section of an aperture 400 defined in a membrane 402 of the illustrative optical metasurface. FIG. 4E shows the E field enhancement profile along the dashed line of FIG. 4A, i.e., along the x axis. As shown in these figures, the magnitude of the E field enhancement within the apertures is surprising, reaching a maximum of about 300 at the interface formed between the aperture 400 and the solid material of the membrane 402 and over 100 across most of the aperture 400. As is also shown in these figures, some enhanced electric field within the solid material of the membrane 402 is present, although the electric field enhancement is desirably localized outside of the solid material and within the apertures.

In embodiments, such as the illustrative optical metasurface of FIGS. 4A and 4E, the metasurface pattern is configured to support a bound state in the continuum (BIC) optical mode. BIC optical modes confine light through destructive interference of outgoing electromagnetic waves or incompatible symmetry between the confined light and free space. Recognizing the known, inherent limitations related to the disclosed fabrication techniques and material defects, the phrase “BIC optical modes” encompasses “quasi-BIC (q-BIC) optical modes.” Moreover, reference to a “BIC optical mode” may refer to a particular mode thereof, including a transverse electric (TE) mode or a transverse magnetic (TM) mode. For example, the optical mode exhibiting the extremely high E field enhancements within the apertures of the illustrative optical metasurface (as shown in FIGS. 4A and 4E) is a BIC TE optical mode.

Optical metasurfaces, metasurface patterns, and apertures thereof, which are configured to support a certain optical mode (e.g., a BIC optical mode) may be referred to herein as BIC optical metasurfaces, BIC metasurface patterns, and BIC apertures. Similarly, when incoming light is resonant with the certain optical mode (e.g., the BIC optical mode), this condition may be referred using “BIC resonance” (and like terms) and the apertures may be referred to as “BIC resonators” (and like terms).

In general, resonance mechanisms in optical metasurfaces involve manipulation of light at the sub-wavelength scale via various physical phenomena supported by individual resonators therein (i.e. individual apertures and/or groups of apertures which constitute the periodically repeating unit cell of the optical metasurface). Illustrative resonance mechanisms include electric and magnetic dipole and multipole resonances, Fabry-Perot, Toroidal, and Mie resonances. Moreover, when the resonator(s) making up the unit cell is periodically organized in the optical metasurface, the fundamental modes listed above collectively couple, inducing other resonance modes such as BIC optical modes, Fano optical modes, as well as quantum optical phenomenon such as electromagnetically induced transparency. Thus, also encompassed are optical metasurfaces, metasurface patterns, and apertures thereof, which are configured to support any of these other illustrative resonance mechanisms and optical modes.

As shown in FIGS. 4B, 4C, 4D, 4E, and 4G, the configuration of the present metasurface pattern may support multiple optical modes exhibiting different E field enhancement characteristics in addition to the aperture-localized optical mode described above. By way of illustration, the metasurface pattern configured to support the BIC TE optical mode shown in FIGS. 4A and 4E also supports other optical modes (including other BIC optical modes) having different E field enhancement characteristics. Specifically, the metasurface pattern supports photonic crystal guided TE and TM optical modes (GM TE and GM TM optical modes) as well as a BIC TM optical mode. Notably, however, the BIC optical modes are both characterized by significantly greater E field enhancements (including much greater maximum E field enhancements) as compared to the photonic crystal guided optical modes. This includes the BIC TE optical mode characterized by significantly greater E field enhancement throughout the aperture 400 (i.e., along each of x, y, and z) as compared to the E field enhancement of the GM TE optical mode. Moreover, the BIC optical modes tend to enhance the E field outside the solid material of the membrane 402 while the photonic crystal guided optical modes tend to enhance the E field within the solid material of the membrane 402. Finally, as described in detail above, the BIC TE optical mode strongly enhances the E field within the apertures (including aperture 400) while the BIC TM optical mode tends to enhance the E field on the upper and lower surfaces of the membrane 402.

The aperture-localized light confinement and E field enhancement distinguishes the present metasurface patterns and optical metasurfaces from designs used in other photonic crystal devices configured to confine light within the solid material from which the membrane is composed. This includes other photonic crystal devices configured to emit light, e.g., laser light. The configuration of the present optical metasurfaces may be characterized as being non-emitting, by which it is mean that the optical metasurface itself does not support light emission, including laser light emission. However, this does not preclude the inclusion of a light-generating material (e.g., quantum dots) within the apertures of the present optical metasurfaces to generate cavity-enhanced light generation. The present metasurface patterns and optical metasurfaces may be further distinguished from light filters that may block light, but do not support any specific optical mode and associated resonance.

The configuration of the metasurface pattern (including the metasurface pattern 112) that ensures the functionalities (e.g., aperture-localized light confinement and E field enhancement, specific optical mode, suppression of photonic crystal guided modes, etc.) described above includes geometric parameters such as the dimensions, shapes, and arrangement of the apertures defined in the membrane. Aperture dimensions and aperture shapes have been generally described above. Aperture arrangement encompasses the positioning of apertures within in the membrane and relative to one another. The material of the membrane (also described above) is another physical parameter that affects its functionality.

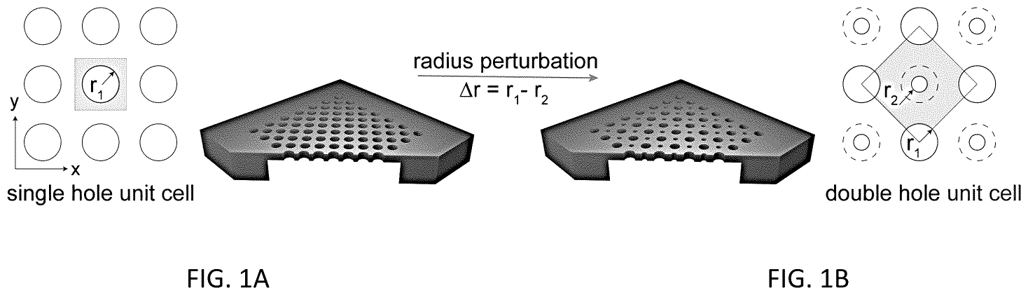

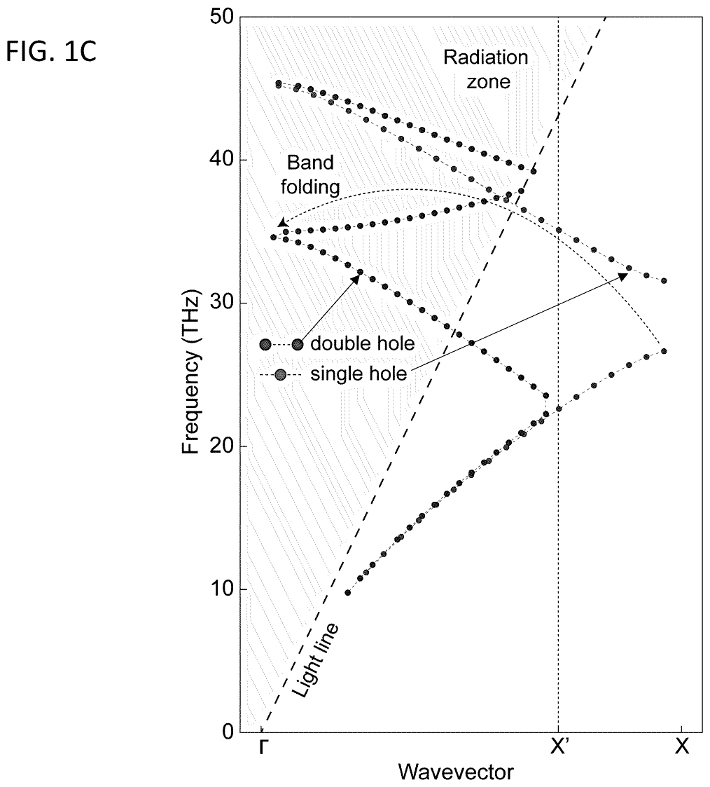

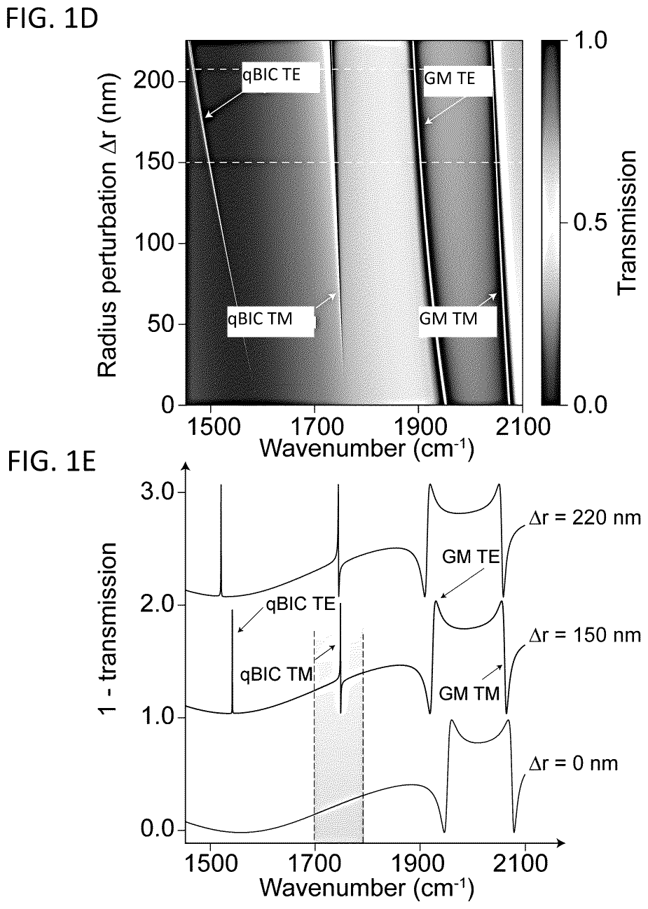

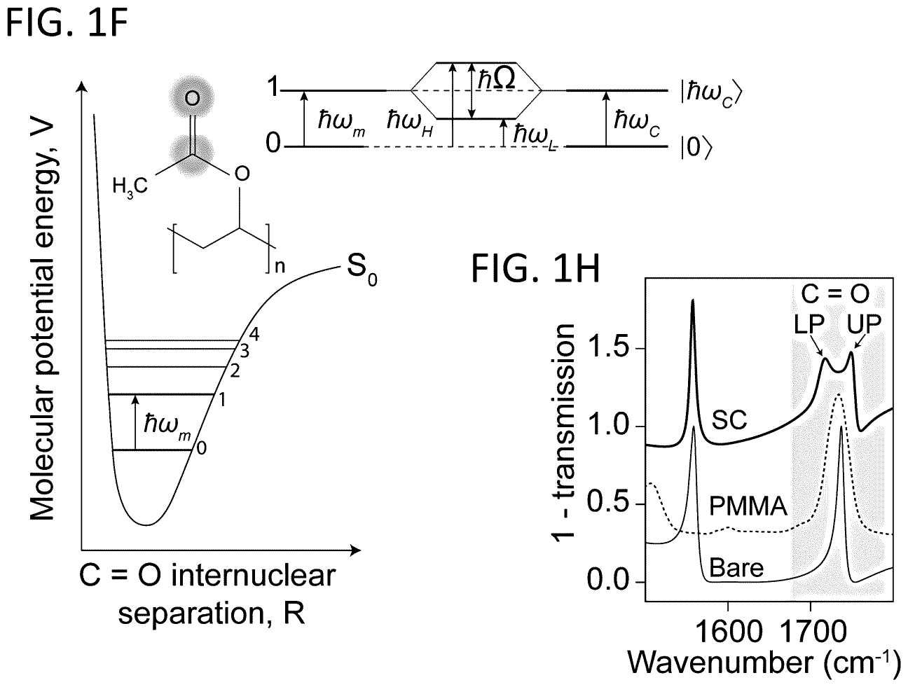

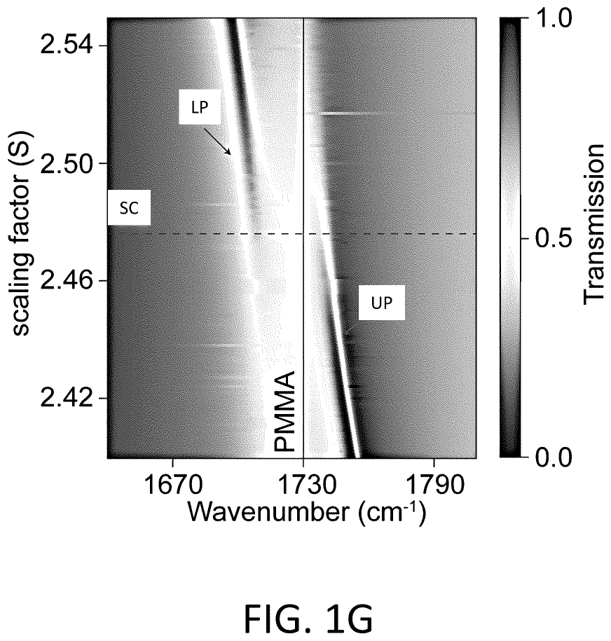

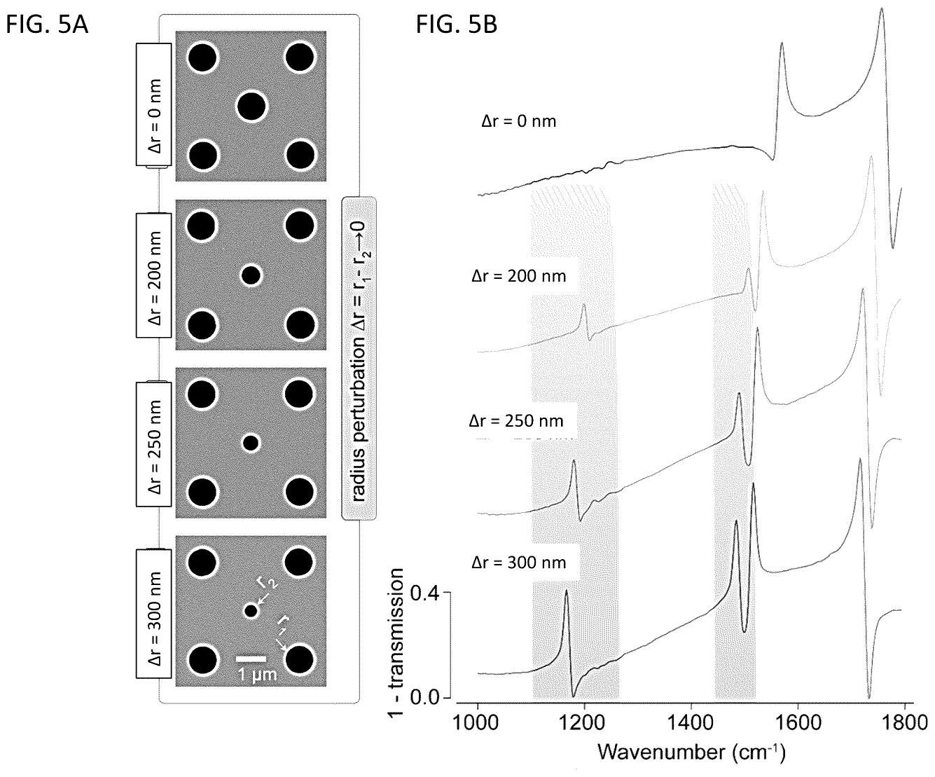

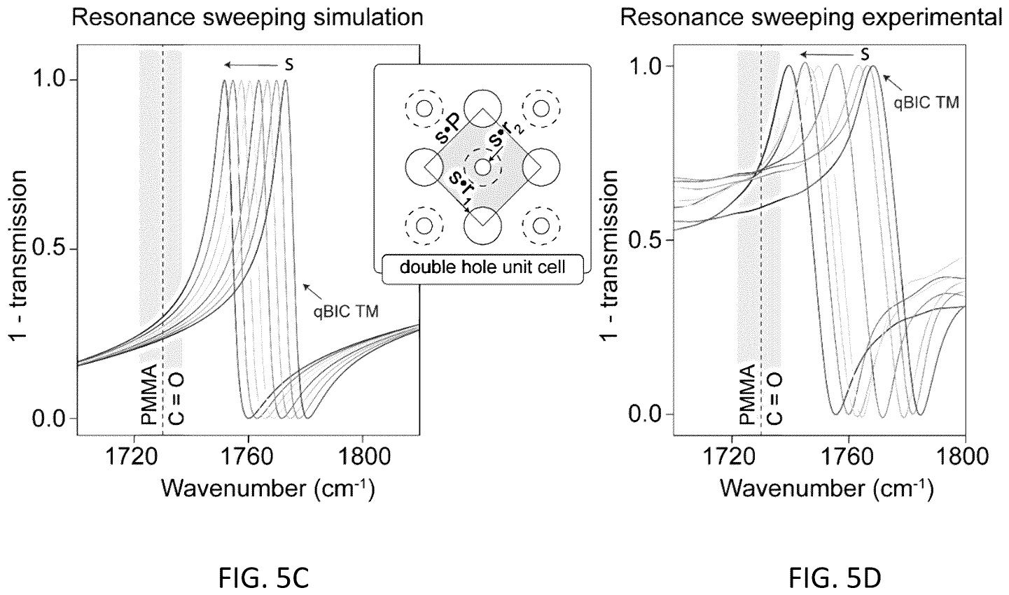

Regarding the geometric parameters, by way of illustration, a “double hole” metasurface pattern configured to support a BIC TE mode is shown in FIGS. 1B and 2C-2D. This metasurface pattern is based on Brillouin zone folding achieved by using two square two-dimensional (2D) arrays of circular apertures. One square array includes circular apertures having radii r₁ and the other square array includes circular apertures having radii r₂, wherein r₁>r₂. The two square arrays are positioned relative to each other to define a repeating metaunit (i.e., unit cell) of the metasurface pattern that includes five apertures, the central aperture having the smaller radius r₂ and the four corner apertures each having the larger radius r₁. A radius perturbation parameter, Δr, may be defined which corresponds to r₁-r₂. Other geometric perturbation methods can also be used to induce BZF BIC modes, such as shifting every other hole's position in x, y or a combination thereof. The periodicity P corresponds to the distance between the centers of apertures having the same radius; thus, the periodicity P of the larger apertures is smaller than the periodicity P of the smaller apertures. A scaling parameter s may be defined that may be used to adjust parameters such as r₁, r₂, P, etc. by the same factor (see the double hole unit cell in FIG. 5C).

The parameters described above, including the geometric parameters, may also be selected to achieve desired optical properties, including a desired E field enhancement, a desired Q factor, and a desired metasurface resonance wavelength (lᵣₑₛ). Regarding E field enhancement, the parameters may be selected to achieve an E field enhancement of at least 100 within an aperture (or all apertures). This includes at least 250, at least 500, at least 750, or within a range of between any of these values, including between 100 and 1000. These values may refer to an average value of the E field enhancement within an aperture (or all apertures) or a maximum value of the E filed enhancement within an aperture (or all apertures). E field enhancement values may be determined from E field enhancement profiles, which may be obtained using the techniques described in the Example, below. (See, e.g., FIG. 4E.) Regarding Q factor, the parameters may be selected to achieve a Q-factor in a range of from 102 to 104. Q factor is defined by the ratio of the resonance wavelength to the full width at half maximum of the resonance peak or dip extracted from the spectral measurements. Regarding lᵣₑₛ, as noted above, this refers to the wavelength (energy) at which the relevant optical mode of the optical metasurface and the incoming light are under resonance. The lᵣₑₛ depends upon the desired application for the optical metasurface (which are further described below), but the wavelength may be within the IR portion of the electromagnetic spectrum, including the MIR portion thereof. Values of lᵣₑₛ may be determined from spectral response plots, which may be obtained using the techniques described in the Example, below. (See FIGS. 1E, 5C, 5D, 8C.)

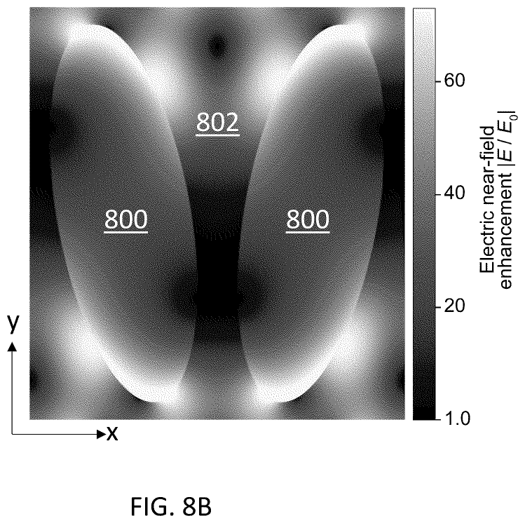

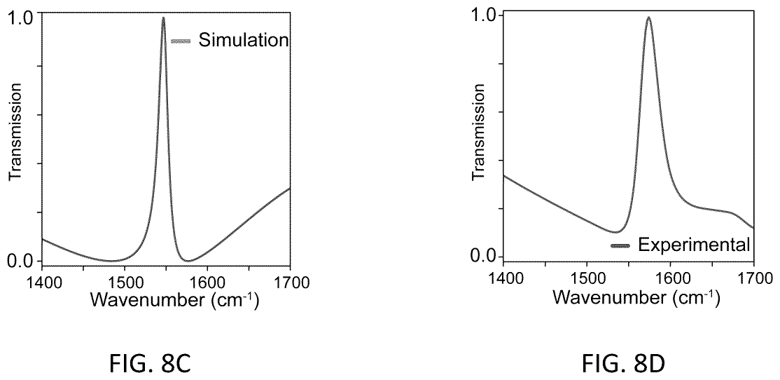

Another illustrative metasurface pattern which is configured to support an optical mode (a BIC optical mode) characterized by aperture-localized light confinement and enhanced E field is a “tilted-rod” metasurface pattern as shown in FIG. 8A. In this metasurface pattern, the repeating metaunit includes two elliptical apertures that are tilted away from one another at an angle θ. FIG. 8B shows the E field enhancement along a x-y cross-section of a portion of the optical metasurface. In FIG. 8B, the solid material of the membrane is labeled 802 and the apertures are labeled 800. FIG. 8C plots the calculated and FIG. 8D plots the measured spectral response of the optical metasurface. In this metasurface pattern, the Q factor can be tuned by its geometric parameter, θ.

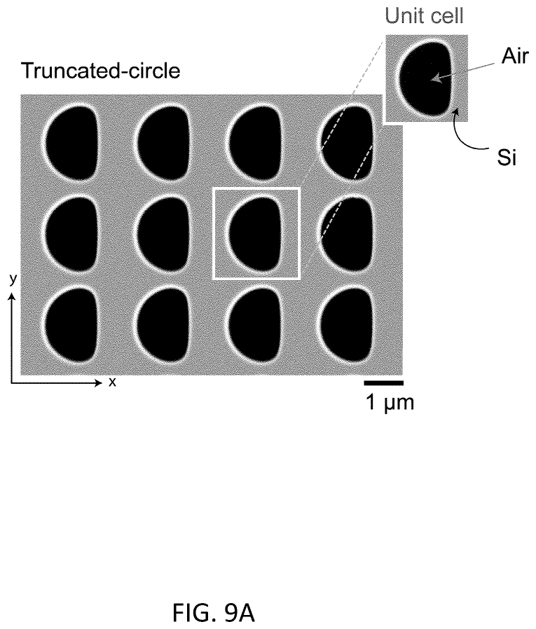

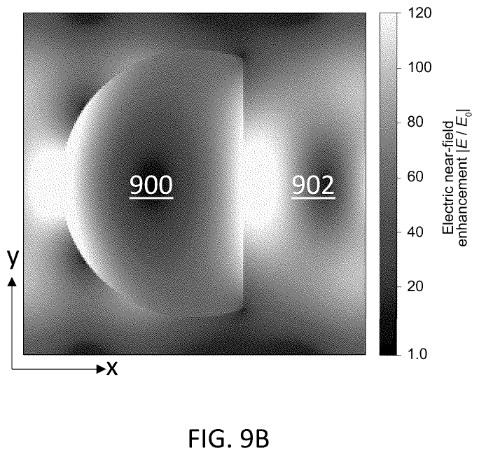

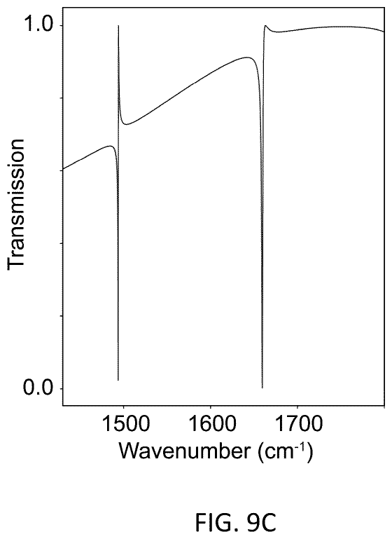

Another illustrative metasurface pattern which is configured to support an optical mode characterized by aperture-localized light confinement and enhanced E field is a “truncated-circle” metasurface pattern as shown in FIG. 9A. In this metasurface pattern, the repeating metaunit is an individual truncated-circle. FIG. 9B shows the E field enhancement along a x-y cross-section of a portion of the optical metasurface. In FIG. 9B, the solid material of the membrane is labeled 902 and an aperture is labeled 900. FIG. 9C plots the simulation calculated spectral response of the optical metasurface. The truncated-circle metasurface design has two resonance modes, one at 1495 cm⁻¹ and the other one at 1660 cm⁻¹.

The present optical metasurfaces configured as set forth above enable samples present within the apertures to access, and thus interact with, the optical mode volumes and enhanced E fields generated within the apertures upon coupling light therein. As such, the optical metasurfaces may be used to detect, identify, and/or study such samples. This includes using the optical metasurfaces to carry out a variety of spectroscopic techniques, e.g., surface-enhanced infrared spectroscopy (SEIRAS). Thus, the optical metasurfaces may be used for chemical and biochemical fingerprinting and sensing in a variety of applications employing these spectroscopic techniques, e.g., medical diagnostics, industrial process monitoring, and fuel supply quality monitoring.

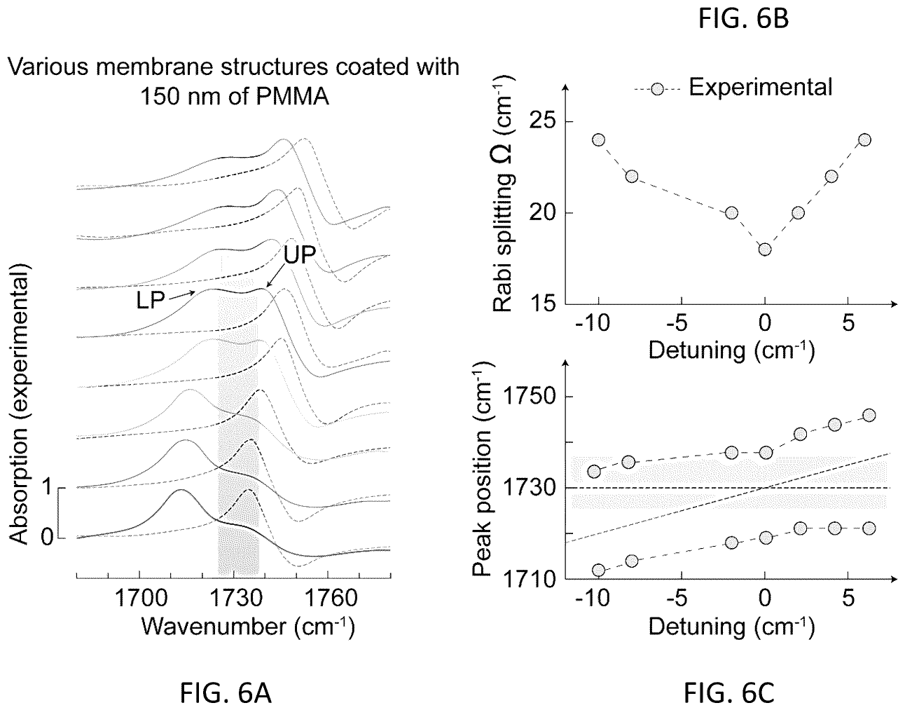

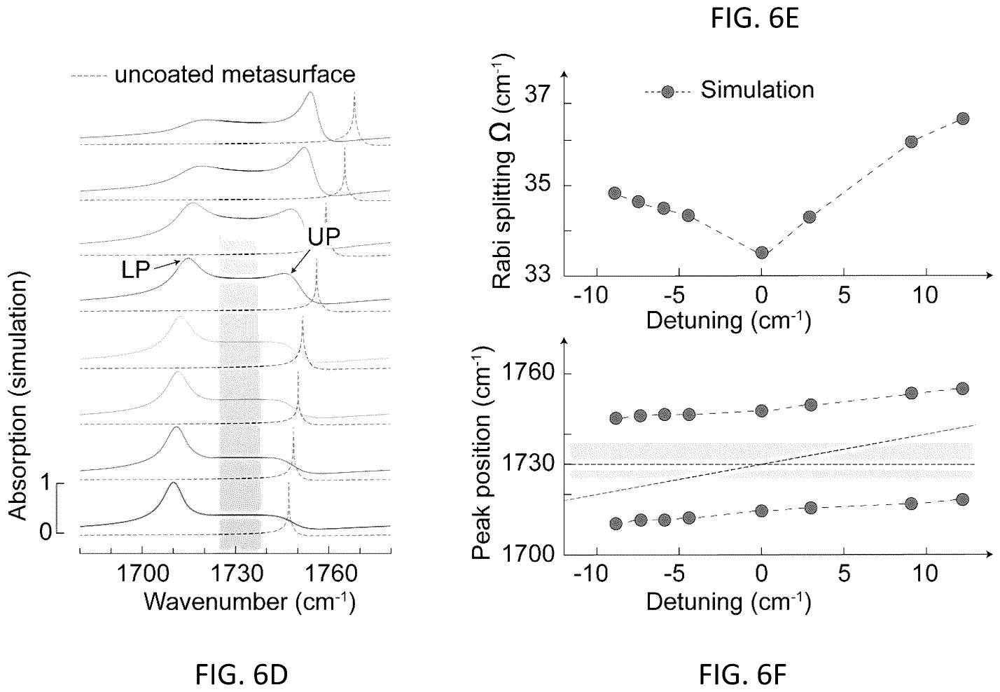

The present optical metasurfaces may also be used in polaritonic chemistry applications. Specifically, by appropriate selection of the metasurface pattern (as described above), sufficiently high E field enhancement may be achieved so as to induce vibrational strong coupling (VSC) between a molecule present within an aperture and an excited optical mode of the optical metasurface. (By “excited” it is meant that the optical mode is resonant with light being coupled into the optical metasurface.) This includes enabling coherent energy exchange between a quantum state (e.g., a vibrational mode) of the molecule and the excited optical mode sufficient to entangle quantum states and generate polaritons, i.e., hybrid light-matter states. In fact, due to the surprisingly high electrical field enhancements with the apertures of the optical metasurfaces, the Example, below demonstrates use of an illustrative optical metasurface to induce VSC between the C═O stretching vibrational mode of polymethyl methacrylate (PMMA) molecules present within the apertures of the optical metasurface and an excited BIC TE optical mode thereof. (See FIGS. 6A-6B.) These figures further show the formation of a polariton pair (a lower polariton, LP and an upper polariton, UP) and the Rabi splitting therebetween. Thus, confirmation that an optical metasurface is suitably configured to induce VSC and generate polaritons may be accomplished using spectral techniques similar to those described in the Example below.

The light-trapping ability of the present optical metasurfaces further enables their use in various light-induced particle trapping applications to trap particles for quantification, analysis, and/or removal. This includes using the optical metasurfaces to trap biological samples (e.g., exosomes, bacteria, virus, fungi cells, etc.) from biofluids as well as to trap particles (e.g., micro/nanoplastics, aerosols, etc.) for environmental monitoring and remediation.

The samples to be analyzed using the present optical metasurfaces, including using any of the techniques and applications described above, comprise a species (e.g., a molecule) and may further comprise a medium that provides the species. The medium and species are not particularly limited provided the sample has an index of refraction smaller than that of the membrane material from which the optical metasurface is formed. The sample may be a solid or a fluid (i.e., a liquid or a gas). However, here “gas” does not preclude a species being provided under vacuum conditions.

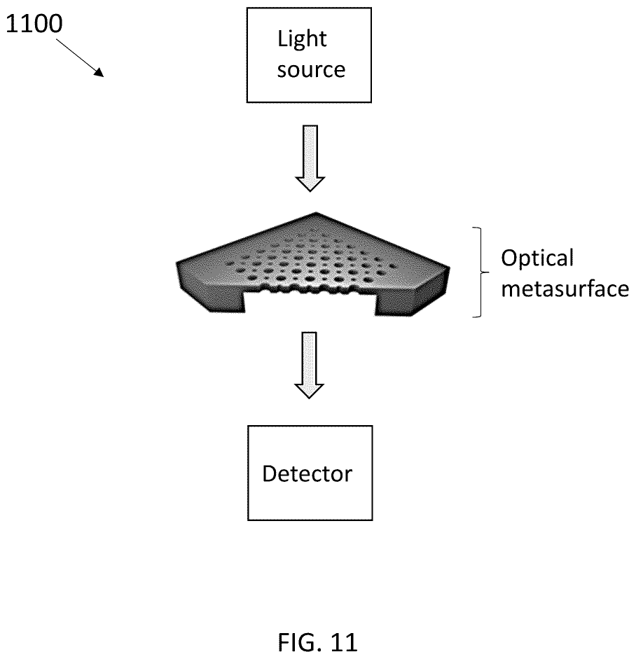

The present disclosure also encompasses the optical metasurfaces fabricated using the methods described herein as well as devices incorporating the optical metasurfaces. The type of device depends upon the desired application. However, an illustrative device is a sensor comprising any of the disclosed optical metasurfaces and which may further comprise a variety of other components, e.g., a sample delivery assembly configured to deliver a sample to apertures of the optical metasurface; a light source configured to provide light to be coupled into the optical metasurface; and a detector configured to detect light, e.g., light transmitted through the optical metasurface. A schematic illustration of a sensor 900 is shown in FIG. 11. The sensor 900 comprises the optical metasurface of FIG. 1B, a sample delivery assembly (not shown), a light source, and a detector. Light delivery and collection optics such as objectives are also generally included. Various other optical elements, electrical elements, controllers, etc., may be included. As shown in FIG. 11, the light source and the detector may be positioned on opposing sides of the optical metasurface.

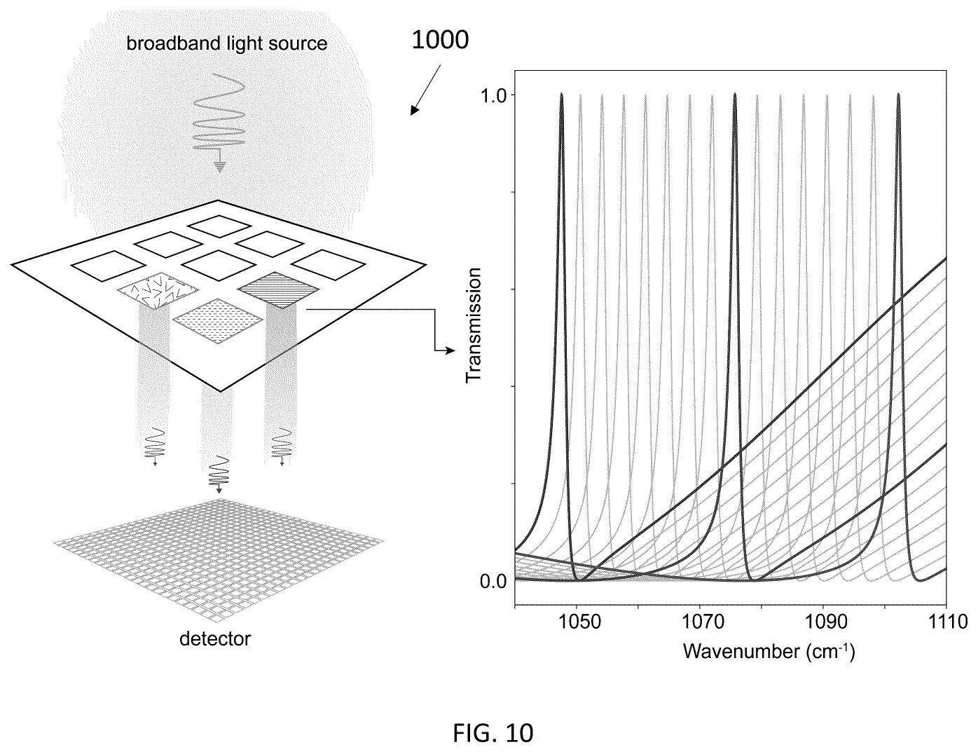

In the devices, including sensors, more than one of the disclosed optical metasurface may be used, which may also be arranged in a periodic array. (See, e.g., the 4×4 array of optical metasurfaces shown in FIG. 2B.) The metasurface patterns in each optical metasurface may be the same or different. FIG. 10 illustrates another device, a spectrometer 1000, comprising 3×3 array of optical metasurfaces. In this embodiment, the metasurface patterns in the optical metasurfaces are different so as to enable transmission of different wavelengths of light according to the respective lᵣₑₛ and resonance bandwidth of each optical metasurface.

The present disclosure also encompasses methods of using any of the disclosed optical metasurfaces. The specific steps of the method depend upon the desired application. However, the methods may comprise delivering a sample into apertures of the optical metasurface; coupling light into the optical metasurface; and detecting light, e.g., light transmitted through the optical metasurface. The coupling of the light may be conducted under conditions that achieve resonance with a desired optical mode (e.g., a BIC TE optical mode) of the optical metasurface. This may include selecting a wavelength that is resonant with the desired optical mode of the optical metasurface (or a wavelength range encompassing such a wavelength), as well as selecting an appropriate intensity and light coupling technique (e.g., normal incidence light illumination as used in the Example, below). Detecting may be carried out as a function of time, wavelength of light, or both.

### Example

### Introduction

This Example presents a novel concept of substrate-less qBIC-supporting metasurfaces that can efficiently trap light in air cavities for VSC. This approach to fabricating low-loss metasurfaces involves perforating a hole pattern into a free-standing high-index Si-membrane. By periodically perturbing the size of the hole radii (FIGS. 1A, 1B), the size of the Brillouin zone was engineered in the k-space (FIG. 1C) and the light dispersion band folding scheme was modified. In this unique design, Brillouin zone folding (BZF) introduced a leak into the trapped guided modes (GMs), converting them to q-BIC resonances, also called BZF-induced BIC modes. Typical for qBIC modes, this Example shows control over radiation channels via a radius perturbation parameter Δr, which modifies the Q-factor (FIGS. 1D, 1E). Moreover, the fabricated metasurfaces were numerically and optically characterized by identifying their resonance types and mode properties evaluating their suitability for enhancing light-matter interactions. Finally, the VSC between the qBIC resonances and the C═O stretching mode of the polymethyl methacrylate (PMMA) molecules at 1730 cm⁻¹ (FIGS. 1F, 1H) was demonstrated by identifying the polariton formation and measuring the signature Rabi mode splitting over a range detuning frequencies, ω_{PMMA}-ω_{qBIC}. The experimental findings closely correlated with the numerically calculated spectral anti-crossing pattern as illustrated in FIG. 1G and revealed the collective VSC strength as a function of amount of material in the qBIC cavity. Altogether, this Example introduces a new class of substrate-less Si-membrane metasurfaces that are completely CMOS manufacturing compatible and impact polaritonic light-matter interactions by enabling VSC in powerful open cavities in the MIR.

### Materials and Methods

### Numerical Simulations

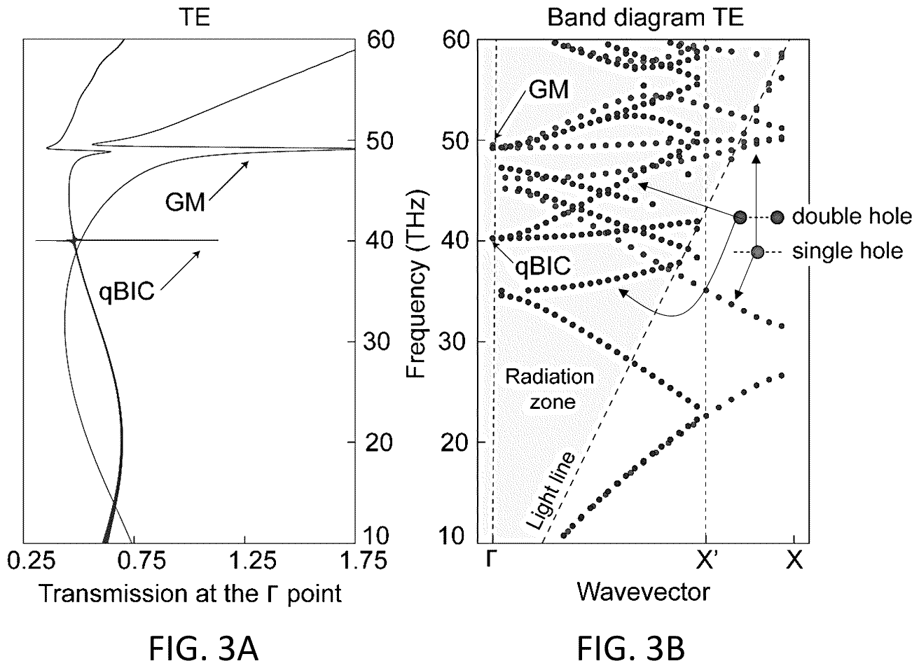

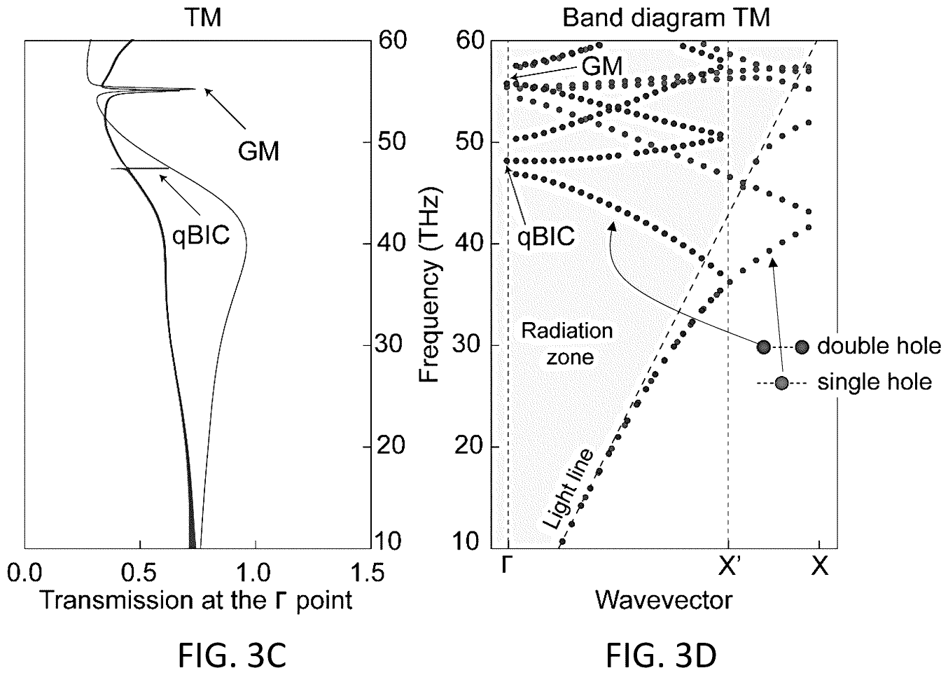

The transmission spectra of the metasurfaces, except the ones in FIGS. 3A, 3C, were calculated using a finite-element frequency-domain solver (CST Microwave Studio 2023, Dassault Systèmes, France). The band diagrams in FIG. 1C and FIGS. 3B, 3D, and the transmission spectra in FIGS. 3A, 3C were calculated using Tidy3D (Flexcompute, California, USA), a commercially available, large-scale finite-difference time-domain (FDTD) solver. The metasurfaces were designed based on the simulations using periodic boundary conditions along the x- and y-directions and perfectly matching layer (PML) along the z-direction. To tune the TM qBIC resonances to the absorption band of the PMMA C═O bond (1730 cm⁻¹), the following geometric parameters for the double-hole design were used: period P=3.54 μm, large hole radius r₁=0.9 μm, small hole radius r₂=0.54 μm, and membrane thickness t=1 μm. All structures were illuminated using a Gaussian beam with adequate spectral coverage from the top of the structure at normal incidence. For band diagram calculations, field time monitors were placed inside the membrane; for transmission spectra calculations, flux monitor was placed underneath the metasurface.

### Fabrication of Free-Standing Membrane Dielectric Metasurfaces

Single-crystal 1-μm thick Si-membranes (2.8 mm×2.8 mm), supported by a 300 μm Si frame (10 mm×10 mm), were used to fabricate the metasurfaces. The membranes were fabricated by first lithographically patterning the membrane openings on the Si handle side of silicon-on-insulator wafers. Then, the Si handle and the buried SiO₂ were removed using wet etching techniques to release the free-standing Si-membranes. To pattern the metasurface designs, a polymethyl methacrylate (PMMA-A8, Kayaku Advanced Material, Massachusetts, USA) resist layer was spin-coated at 4000 rpm and baked for 10 min at 180° C. Metasurface areas of 300 μm×300 μm were then patterned by electron beam lithography using a 100 keV electron beam. After exposure, the PMMA was developed in MIBK: IPA 1:3 solution for 90 s. Subsequently, the holes in the membrane were formed using deep reactive ion Si etching, and the PMMA was stripped by acetone. To remove any PMMA residues from the dielectric metasurfaces, a 6-minute oxygen plasma treatment step was performed.

### Pmma Spin Coating and Thickness Characterization

Various thicknesses of PMMA were obtained by combining the usage of PMMA (Kayaku Advanced Material, Massachusetts, USA) with different molecular weights, dilutions in anisole, and spin-coating speeds. To measure the PMMA thickness, for each metasurface coated with PMMA, a bare Si chip of the same size was also PMMA coated using identical parameters. An ellipsometer (J. A. Woollam, Nebraska, USA) and a reflectometer (Filmetrics, California, USA) were used to measure PMMA thickness on bare Si substrates.

### Optical Setup and Measurements

Mid-infrared spectral measurements were done using a tunable quantum cascade laser (QCL) integrated into a mid-infrared microscope (Spero-QT, Daylight Solutions, California, USA). Using four QCL modules, the microscope can collect spectra covering the fingerprint spectral region from 950 to 1800 cm⁻¹ with 2 cm⁻¹ spectral resolution. During acquisition, the sample chamber was continuously purged with dry nitrogen to clear out water vapor. The spectral data was acquired in a transmission mode using a 12.5×IR objective (pixel size 1.3 μm, 0.7 NA) and detected using an uncooled microbolometer focal plane array with 480×480 pixels obtaining a field of view of 650 μm×650 μm.

### Data Processing

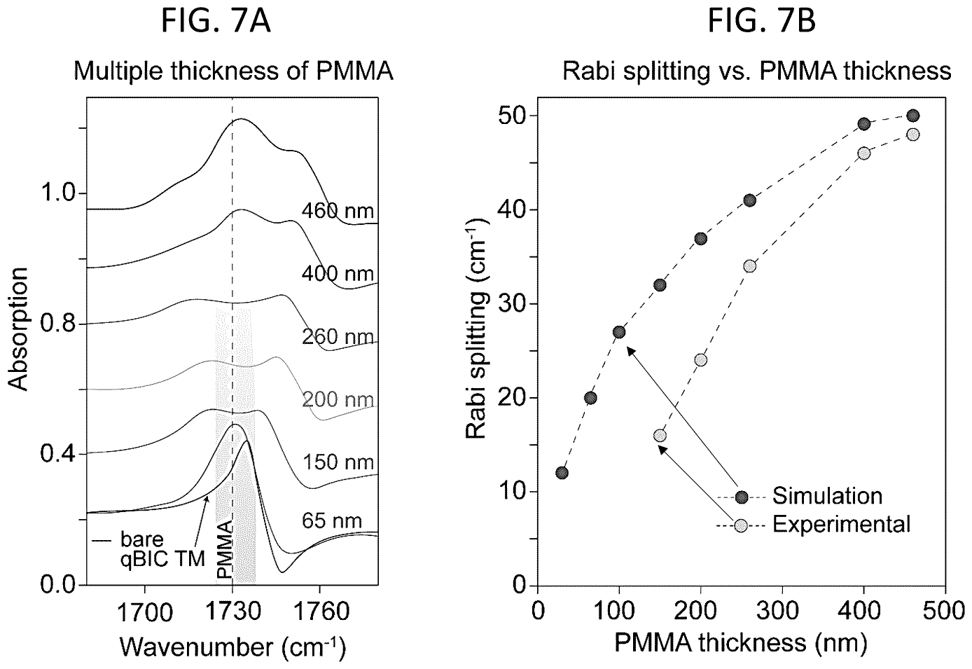

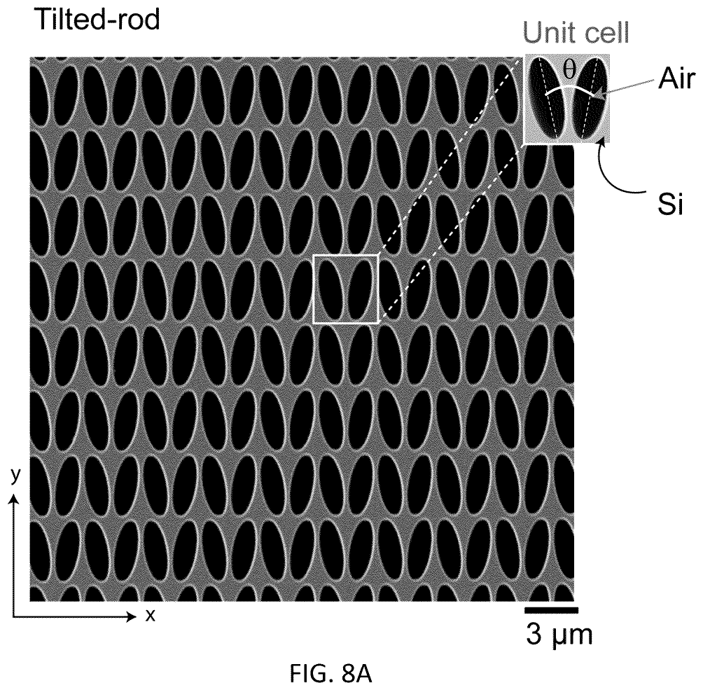

The acquired data was processed by custom-made scripts using MATLAB (Math Works, Massachusetts, USA). For baseline correction, a third-degree polynomial was fitted to each spectrum collected from metasurfaces and then subtracted from the signal to remove the Fabry-Perot background caused by the 1-μm thick Si-membrane. For the VSC measurements shown in FIGS. 6A, 6D and 7A, image registrations were performed between the hyperspectral image datasets collected before and after PMMA coating to ensure a comparison of the same metasurface regions. To determine polariton spectral peak positions, the second derivative of the spectrum was calculated and smoothed using a Savitzky-Golay (SG) filter with a window width of 13 data points. The dips in the second derivative reveal the spectral positions of the peaks in the spectrum, and those of upper and lower polaritons were identified to obtain the Rabi splitting Ω.

### Results

### Metasurface Structure and Fabrication

To fabricate the substrate-less all-dielectric metasurfaces, free-standing single-crystal <100> Si-membranes (thickness=1 μm) with 2.8 mm×2.8 mm dimensions (FIG. 2A) were used. The membranes were formed by first patterning the membrane areas on a silicon-on-insulator wafer, and then etching the Si handle and the buried SiO₂. The metasurface designs were patterned on the membranes using electron beam lithography, and then deep reactive ion etching was used to transfer the patterns by carving through the membranes and forming air holes (FIG. 2E). This is contrary to conventional dielectric metasurfaces that are composed of an array of high-index subwavelength structures fabricated on solid, bulk substrates. For purposes of comparison, the image to the right in FIG. 2E shows a comparative structure formed on a solid, bulk substrate as is used in conventional techniques for fabricating optical metasurfaces. By contrast, this Example describes an inverted approach in which subwavelength resonator arrays of low-index air holes were buried in a free-standing high-index dielectric membrane. Thus, the substrate was eliminated. FIG. 2B shows a typical fabricated 4-by-4 metasurface array, where each metasurface dimension is 300 μm×300 μm. Scanning electron microscopy (SEM) images of the fabricated metasurfaces with a double-hole design are shown in FIGS. 2C, 2D, where the inset shows a metaunit with its critical geometric design parameters that were used to tune the optical resonance properties.

Brillouin Zone Folding (BZF) Induced Quasi-Bound States in Continuum (q-BIC) Resonances.

This Examples describes an approach to engineering BZF-qBIC supporting metasurfaces that involves introducing periodic perturbations to a photonic crystal slab with a square array of air holes, which was called the single-hole design. To bring the photonic crystal guided modes (GMs) to the MIR region, the single-hole design featured hole radii of r=0.9 μm with periods P=2.46 μm. Then, the radii of every other hole in both x and y directions were reduced by Δr, which changed the unit cell and enlarged its period by a factor of \sqrt{2} to P=3.48 μm. This radius perturbed metasurface design was called the double-hole design. FIGS. 3A and 3C show the simulated TE and TM transmission spectra of the single-hole and double-hole metasurfaces (Δr=0.36 μm) that were excited with normal incident light (Γ-point). At the Γ-point, the double-hole structure's dispersion relation had qBIC and GM modes, whereas the single-hole structure supported only the GM mode. The TE and TM modes were excited separately in the simulation by setting the appropriate symmetry conditions with respect to the mirror plane parallel to the membrane, even for TE and odd for TM. Further simulation details can be found in the materials and methods section above. In the double-hole design, periodic radius perturbation shifted the Brillouin zone from X to X′, folding all the fundamental photonic crystal TE and TM modes (FIGS. 3B, 3D). The qBIC modes emerged due to the rearranged modes at lower k-values, enabling free-space excitation of the GMs originally located below the light cone. Notably, the radius perturbation in the double-hole design introduced radiative leakage channels and thus enabled free-space access to the symmetry-protected BIC modes at the Γ-point (FIGS. 3A, 3C). Thus, BZF-qBICs emerged as free-space-accessible resonances at the Γ-point, whose Q-factors were controlled by perturbation, Δr, in contrast to their counterparts in the single-hole design, which were inaccessible (hence their infinite lifetime).

The near-field characteristics of the resonances supported by the single-hole and double-hole metasurfaces were further analyzed to investigate their suitability for cavity-enhanced light-matter interaction studies. FIGS. 4A-4D show the electric (E) field enhancement profiles of qBIC TE, GM TE, qBIC TM, and GM TM modes across the x-z plane of the membrane, which extended in the x-y plane. Simulation results revealed that qBIC modes can enhance the E-field significantly better than the GMs (˜5-fold). Notably, the electric field hotspots were predominantly formed on the exterior surface of the metasurface. Specifically, the qBIC TE mode can efficiently trap the E-field in the center of the smaller air holes, whereas qBIC TM modes concentrated theirs on the membrane surface. This is because the TE modes were even with respect to the mirror plane parallel to the membrane, and thus, its electric field direction was along the slab. This is in contrast to the odd symmetry of TM modes, which made its E-field direction perpendicular to the slab. FIGS. 4E and 4G show the field enhancement profiles along the corresponding dashed lines indicated on the maps. Once again, herein, the superiority (˜300 vs. ˜60 for TE and ˜230 vs. ˜45 for TM) of the field enhancement of the qBIC modes over the GM modes was highlighted. Finally, the bulk refractive index sensitivity (S=Δλ/Δn) of each mode (FIGS. 4B, 4F) was calculated. Eqn. 1, below, shows the relation between resonance frequency shift Δω of a mode for a given permittivity perturbation Δε. Resonance frequency is denoted as ω, resonance frequency shift Δω, electric field E, and permittivity of the perturbation Δε. Because qBIC modes can concentrate light in air cavities much better than GMs, the qBICs' resonance wavelengths shift more per refractive index unit (RIU) perturbation. Notably, even when qBIC TM had a smaller nominal maximum field enhancement compared to qBIC TE (˜230 vs ˜300), the qBIC TM resonance still exhibited the highest overall refractive index sensitivity to its surrounding media among all four studied modes. This indicates that qBIC TM had overall higher field enhancement throughout its surroundings compared to qBIC TE, as can be seen from Eqn. 1. Therefore, the inventors chose to work with this mode in the following VSC experiments.

$$Δ ω = - \frac{ω}{2} \frac{\int {d}^{3} r Δ ε ( r ) {\vert E ( r ) \vert}^{2}}{\int {d}^{3} r ε ( r ) {\vert E ( r ) \vert}^{2}} \qquad ( 1 )$$

Subsequently, double-hole metasurfaces were fabricated with varying radius perturbations. FIG. 5A shows the SEM images of the metaunits of four different designs with Δr=0, 200, 250, and 300 nm. A critical constraint in applying high-Q metasurfaces in real-world applications is the spectral resolution limits of the instruments used in the optical interrogation of the sharp resonances. To optically characterize the fabricated metasurfaces, in this Example, a quantum cascade laser-based illumination with a minimum 2 cm⁻¹ spectral tunability limit was used. Thus, the Δr values were chosen to be large enough to be able to measure the resonances on the optical setup. FIG. 5B shows the measured spectral responses with varying radius perturbations. In accordance with the simulation results, the TE and TM qBIC mode amplitudes decreased as Δr approached zero until they finally disappeared at Δr=0 nm. Since the illumination can excite both TE and TM modes simultaneously, each measured spectrum shows all four modes (TE, TM GMs, and qBICs). Notice that the GMs' linewidths were barely affected by the change of Δr. On the other hand, the decrease in radius perturbation, Δr, led to amplitude shrinkage of qBIC resonances. This was a result of the combined effects of the spectral resolution limit of the optical setup in failing to capture the ultra-sharp resonance peaks and the suppressed radiation channels as the Q-factor increases with decreasing Δr. Compatible with the optical setup, the inventors chose to work with the qBIC resonances generated by the metasurfaces with Δr=300 nm.

Moreover, to demonstrate the spectral tunability of the qBIC modes, the metaunit design parameters were adjusted by scaling parameter s (FIG. 5C, inset). FIGS. 5C and 5D show the calculated and measured qBIC TM resonances, respectively, with peaks tuned to different wavenumbers. Here, the absorption peak associated with the C═O vibrational bond of the PMMA molecule was specifically targeted, which peaked around 1730 cm⁻¹ with a full-width half maximum of 8 cm⁻¹ (shaded in gray in FIGS. 5C, 5D). Expecting a red shift in the resonance peak upon introducing the PMMA molecules into the cavities, a set of metasurfaces was fabricated with resonance speaks slightly higher in wavenumbers (shorter wavelengths) than 1730 cm⁻¹.

Vibrational Strong Coupling (VSC) with BZF-qBIC Cavities

To demonstrate the VSC capabilities of the double-hole metasurfaces, the coupling strength between the vibrational transition associated with the CO bond of PMMA molecules and the qBIC TM resonances was studied. The metasurface array whose resonance peaks were tuned to the right of 1730 cm⁻¹ (FIG. 5D) was first coated with a PMMA layer (t=150 nm). FIGS. 6A and 6B show the measured and simulation-derived absorption spectra as the cavity resonance swept through the absorption peak. Due to the refractive index increase with PMMA coating, the cavity resonances shifted to lower wavenumbers, which can be observed via the uncoated metasurfaces' resonance peaks, plotted in FIGS. 6A, 6B for reference. When the cavity resonance started overlapping with the molecules' vibrational mode, a polariton pair formed. The separation between the lower and upper polariton is defined by the Rabi constant in Eqn. 2, which correlates to the coherent energy exchange between the cavity and molecular states:

$$Ω = \sqrt{4 {g}^{2} + {( δ - i ( {γ}_{P M M A} - {γ}_{qBIC} ) )}^{2}} \qquad ( 2 )$$

where the δ=ω_{PMMA}−ω_{qBIC} is the detuning parameter, γ_{PMMA} and γ_{qBIC} are PMMA and cavity losses, respectively, and g is the coupling strength, which is defined as

$$g = d \cdot E = \sqrt{\frac{( h \cdot ω )}{( 2 \cdot ε \cdot {ε}_{0} V )}} ,$$

where d is the transition dipole moment, E is the cavity's vacuum electric field, ε and ε₀ material and vacuum permittivity, respectively, and V the mode volume. The Rabi splitting reaches a minimum at zero detuning frequency δ=ω_{PMMA}−ω_{qBIC}=0, which matches with the experimental and simulation results (FIGS. 6C and 6D). Moreover, the anti-crossing behavior of the cavity resonance peak position as it swept the molecular vibrational transition band (FIGS. 6E and 6F) was observed.

Finally, to investigate the effect of molecule quantity in the qBIC metasurface cavities, VSC was studied as a function of PMMA layer thickness coated on the metasurfaces. As the number of molecules (N) simultaneously coupled to a cavity increased, the coupling strength was boosted by a factor of \sqrt{N}, known as collective strong coupling. FIGS. 7A-7B show the collective coupling effect as the Rabi splitting increased with the PMMA thickness. As the PMMA layer thickness increased (t>260 nm), the direct absorption of molecules, which were not coupled to the metasurface resonance mode, appeared (FIG. 7A). Due to the resolution limitations of the measurement setup, the polaritons for PMMA thicknesses equal to and less than 65 nm could not be resolved. However, a resonance peak broadening was apparent in the resonance spectrum of the metasurface with the thin (t=65 nm) PMMA coating compared to its uncoated counterpart. This effect is what is usually measured in biological and chemical sensors using SEIRA, which is based on the weak light-matter coupling phenomenon.

### DISCUSSION

Chemistry under VSC is poised to be a new promising method for altering the properties of matter and controlling chemical processes. Despite the progress, substantial knowledge gaps persist in the comprehension of the fundamental principles underpinning cavity-coupled chemistry. These include the roles of coherence and collective VSC on the modification of individual molecules' ground state properties, the effects of dark states in an ensemble coupled system, and VSC to electromagnetic vacuum fluctuations in the absence of external illumination. Similarly, the potential technological impacts of polaritonic chemistry are extensive, offering the capability to steer chemical reactions toward desirable products and to modify enzyme activity via VSC with water. Realizing the full potential of polaritonic chemistry in the wider realm of biochemical sciences requires a cross-disciplinary strategy, particularly leveraging the diverse variety of optical resonators developed by the photonics community. These can provide novel insights into the intricate mechanisms of VSC and facilitate the adoption of polaritonic chemistry on an industrial scale. In this context, the Si-membrane metasurfaces fabricated in this Example, which are fully compatible with CMOS manufacturing processes, offer significant contributions to this burgeoning field.

In order to advance the use of dielectric metasurfaces for VSC applications, the unique Si-membrane metasurface design described in this Example affords numerous benefits: 1) The optical resonance properties of the metasurfaces are not perturbed by any underlying substrate, which have a higher refractive index than air, and decrease the effective refractive index contrast between the resonator and its surrounding media. 2) The hotspots surrounding the metasurface are formed in the air, thus generating accessible photonic cavities. 3) Unlike IR-transparent substrates, which are generally not compatible with high-throughput wafer-scale manufacturing processes, the present free-standing membrane design is fully compatible with CMOS manufacturing as they can be fabricated using conventional silicon-on-insulator wafers. 4) The silicon-based metasurfaces are compatible with existing microfluidics technology, making them compatible with liquid samples. 5) Vacuum photonic cavities that punch through a thin and robust membrane are well suited for applications requiring dynamic light-matter interactions where the liquid or air samples can flow through the holes while optical data is collected in real-time.

To conclude, in this Example, substrate-less Si-membrane metasurfaces supporting qBIC resonances for VSC studies were fabricated and characterized. The Brillouin zone folding method was leveraged to generate robust qBIC resonances that can efficiently trap MIR radiation in air cavities. Optically characterizing the fabricated metasurfaces, the supported resonance types were identified, which aligned with the simulation results. Finally, the VSC between the qBIC resonances and PMMA's C═O vibrational resonance at 1730 cm⁻¹ was showcased by measuring the signature Rabi mode splitting over various detuning frequencies δ=ω_{PMMA}−ω_{qBIC}. The experimental findings closely matched the numerically calculated spectral anti-crossing pattern. Moreover, VSC with various PMMA thicknesses was measured, and the ˜\sqrt{N}-correlation between VSC strength and the number of molecules, N, coupled to a cavity was demonstrated. Altogether, this Example introduced new class of free-standing membrane dielectric metasurfaces that is completely CMOS manufacturing compatible and can impact polaritonic light-matter interactions by enabling VSC in powerful open cavities in the MIR.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

1. A method of fabricating an optical metasurface, the method comprising forming a free-standing membrane from a wafer and forming a metasurface pattern in the free-standing membrane to provide an optical metasurface comprising the free-standing membrane having defined therein, a periodic array of flow-through apertures, the flow-through apertures having subwavelength dimensions and arranged according to the metasurface pattern, wherein the metasurface pattern is configured to confine incoming light within the flow-through apertures.

2. The method of claim 1, wherein the metasurface pattern is configured to support an optical mode characterized by an enhanced electric (E) field within the flow-through apertures.

3. The method of claim 2, wherein the enhanced E field of the optical mode throughout the flow-through apertures is greater than an enhanced E field of a photonic crystal guided mode throughout the flow-through apertures.

4. The method of claim 2, wherein the optical mode is a bound state in the continuum (BIC) optical mode.

5. The method of claim 4, wherein the BIC optical mode is a BIC TE optical mode.

6. The method of claim 2, wherein the enhanced E field is capable of inducing vibrational strong coupling between a molecule present in the flow-through apertures and the optical mode and generating a polariton pair.

7. The method of claim 2, wherein the enhanced E field is at least 50 throughout the flow-through apertures.

8. The method of claim 1, wherein the incoming light is mid-infrared light.

9. The method of claim 1, wherein the free-standing membrane is composed of a dielectric material selected from Group IV elements or Group III-V semiconductors.

10. The method of claim 1, wherein the free-standing membrane is free of a conductive material.

11. The method of claim 1, further comprising forming a resist layer having a resist pattern therein, the resist pattern corresponding to the metasurface pattern.

12. The method of claim 11, further comprising applying the resist layer to a surface of the free-standing membrane prior to forming the resist pattern therein.

13. The method of claim 1, wherein forming the free-standing membrane comprises patterning an opening into a handle of the wafer and etching to release the free-standing membrane; and
further wherein forming the metasurface pattern comprises applying a resist layer on a surface of the free-standing membrane, forming a resist pattern in the resist layer, the resist pattern corresponding to the metasurface pattern, and etching the free-standing membrane to provide the flow-through apertures.

14. The method of claim 1, wherein the free-standing membrane has a thickness of no greater than 10 μm and the subwavelength dimensions are each no greater than 10 μm.

15. The method of claim 1, wherein the metasurface pattern comprises a repeating metaunit comprising four apertures each having a radius r₁ and arranged in a square array; and a central aperture having a radius r₂ wherein r₁>r₂.

16. The method of claim 1, wherein the metasurface pattern comprises a repeating metaunit comprising two elliptical apertures tilted away from one another.

17. An optical metasurface comprising a free-standing membrane having defined therein, a periodic array of flow-through apertures, the flow-through apertures having subwavelength dimensions and arranged according to a metasurface pattern, wherein the metasurface pattern is configured to confine incoming light within the flow-through apertures.

18. A sensor comprising the optical metasurface of claim 17, a sample delivery assembly configured to deliver a sample to at least one of the flow-through apertures; a light source configured to provide the incoming light; and a detector configured to detect light transmitted through the optical metasurface.

19. The sensor of claim 18, wherein the sample delivery assembly is a component of, or is in fluid communication with, a microfluidic control system.

20. A spectrometer comprising an array of optical metasurfaces according to claim 17, wherein each metasurface pattern of each optical metasurface has a different resonance wavelength λᵣₑₛ and resonance bandwidth; a light source configured to provide the incoming light; and a detector configured to detect light transmitted through the array of optical metasurfaces.
